(19) United States
(12) Patent Application Publication
(10) Pub. No.: US 2024/0388163 A1
(43) Pub. Date: Nov. 21, 2024

(54) INTEGRATED MOTOR DEVICE WITH PLUG-CONNECTED MOTOR UNIT AND SERVO DRIVE UNIT

(71) Applicant: Synapticon GmbH, Schönaich (DE)

(72) Inventors: Simon FISCHINGER, Schönaich (DE); Nathanael PELTZER, Schönaich (DE); Andrija FEHER, Schönaich (DE); Florian KOCK, Schönaich (DE)

(21) Appl. No.: 18/690,709

(22) PCT Filed: Sep. 12, 2022
(86) PCT No.: PCT/IB2022/058561

§ 371 Date: Mar. 8, 2024

(30) Foreign Application Priority Data
Sep. 16, 2021 (DE) 10 2021 123 968.0

(51) Int. Cl. H02K 5/22; H02K 11/33

(52) U.S. Cl. CPC H02K 5/225; H02K 11/33

(57) ABSTRACT

The disclosure relates to a motor device with a motor unit and a servo drive unit configured to be attached to the motor unit, where motor unit and servo drive unit are configured to be electrically coupled via a plug connection with one or more plugs, with a preset plug direction (P) of the plug connection running parallel to a motor shaft of the motor unit; where the motor unit and the servo drive unit are configured to be aligned, in an attached state of motor unit and servo drive unit, by means of an aligning contour; and with an encoder system for providing information on the position of the motor shaft with i) an encoder target which is fixed to the motor shaft of the motor unit as part of the motor unit and with ii) an encoder read head which is a part of the servo drive unit; where the encoder target is part of the motor unit both in the attached state of motor unit and servo drive unit and in an unattached state of motor unit and servo drive unit, and the encoder read head is part of the servo drive unit both in the attached state of motor unit and servo drive unit and in the unattached state of motor unit and servo drive unit, so as to improve the design of the motor device, in particular, to simplify the assembly of the motor device.

### INTRODUCTION

The disclosure relates to a motor device with a motor unit and a servo drive unit, the servo drive unit configured to be attached to the motor unit, where motor unit and servo drive unit are configured to be electrically coupled via a plug connection with one or more plugs, with a preset plug direction of the plug connection running parallel to a motor shaft of the motor unit.

Traditional integrated motor devices, which are also referred to as inverter motors or inverter motor devices, are built using servo drives that initially were intended for a nearby use, i.e. close but spatially separated from the motor unit. In the course of history, an end cap fitting the motor unit was developed to house said servo drive in direct proximity of the motor unit. In such an end cap, all cabling has to be arranged within a very constrained, limited space. The signals that are transmitted via said cables in the end cap usually comprise the following: encoder system signals, three phase signals, two direct current (supply) signals, two fieldbus signals, signals of one or several motor temperature sensors, analogue input signals, analogue output signals, digital input signals, as well as digital output signals.

For all these cables, a certain amount of cable reserve has to been kept between the motor unit and the end cap to gain enough space for cabling, since the servo drive is usually mounted into the end cap and wired only afterwards, just before the end cap with the mounted servo drive is, as a servo drive unit, attached to the motor unit. The cable reserve, however, causes the inner parts of the servo drive unit to take up more space than needed for the servo drive components themselves. Furthermore, the cable reserve results in the process of mounting the end cap onto the motor degrading process safety, since cables might be squeezed when attaching the servo drive unit to the motor unit. Such squeezing usually results in a risk of random faults during operation.

Furthermore, a large number of mounting steps, usually including screwing or gluing processes, has to be executed: the servo drive is mounted in the end cap, all wires are connected, after some thermal interface material has been applied the end cap with mounted servo drive is attached to the backside of the motor unit, the whole system is provided with a final sealing. As each individual mounting step is a source of potential failure, production complexity and control overload are increased in a nonlinear way with each additional individual step.

In order to minimize the chance of errors, it has been proposed to use preassembled wiring harnesses. This reduces the number of individual steps that have to be executed manually. Furthermore, the end caps have been increased in size to give more space to the workers and simplify the wiring process.

Another approach is described in the U.S. Pat. No. 7,939,978 B2, where a plug connection with preset plug direction of the plug connection running parallel to a motor shaft of a motor is proposed.

It can hence be considered an objective problem to be solved by the invention at hand to improve the design of known integrated motor devices, in particular, to further simplify the assembly of integrated motor devices.

This problem is solved by the subject-matter of the independent claims. Advantageous embodiments are apparent from the dependent claims, the description, and the figures.

### DESCRIPTION

One aspect relates to a motor device, which can also be referred to as integrated motor device, with a motor unit and a servo drive unit, with the servo drive unit configured to be attached, that is mechanically coupled, to a backside of the motor unit. The backside of the motor unit, in general, refers to the side of the motor unit opposite to the side where a shaft of the motor unit, i.e. a shaft of the motor of the motor unit, is made accessible for applications of the motor device. Motor unit and servo drive unit are configured to be electrically coupled via a plug connection comprising one or more plugs, with a preset plug direction of the plug connection running parallel to the motor shaft of the motor unit, that is parallel to an axial direction of the motor unit. The preset plug direction is the direction in which the parts of the plug connection are moved in order to establish the plug connection. Consequently, the plugs of the motor unit and servo drive unit, respectively, are fixed in a preset relative position with respect to a corresponding body of the motor unit and housing of the servo drive unit, respectively.

The motor unit and the servo drive unit are configured to be aligned, in an attached state of the motor unit and servo drive unit, by means of an aligning contour such as a centering flange. So, the body of the motor unit may feature said aligning contour, with a corresponding counterpart on the servo drive unit side, for instance the housing of the servo drive unit. The body of the motor unit may also be referred to as housing of the motor unit. Consequently, along the alignment contour, the body of the motor unit may be in direct contact with the housing of the servo drive unit. The housing may also be referred to as the end cap of the servo drive unit. So, servo drive unit and motor unit have respective single housings, end cap and body, and the alignment contour preferably comprises one or more parts of one or both of the housings. Thus, servo drive unit and motor unit are self-contained units.

The motor device also comprises an encoder system, a positioning information system, for providing information on the position, i.e. a rotation angle, of the motor shaft. The encoder system comprises an encoder target and an encoder read head. The encoder target may comprise one or several sub-elements, for instance a magnetic pill as multi-turn-target-element and/or an optical disk as single-turn-target-element. The encoder read head as well may comprise one or several sub-elements, for instance a chip reading single-turn information and/or a chip reading multi-turn information and/or a “Wiegand wire”-element harvesting energy for multi-turn readings. The encoder target is fixed to the motor shaft of the motor unit as part of the motor unit, and the encoder read head is a part of the servo drive unit. The encoder target is part of the motor unit both in the attached state of the motor unit and a servo drive unit and in an unattached state of the motor unit and servo drive unit. The encoder read head is part of the servo drive unit both in the attached state of the motor unit and the servo drive unit and in the unattached state of motor unit and servo drive unit. Consequently, the encoder system is a two-part system, with one part, the encoder target, belonging to the motor unit, and the other part, the encoder read head, belonging to the servo drive unit.

This gives the advantage that all required connections between motor unit and servo drive unit, in particular, the electrical connections between motor and electronics, as well as the optical or magnetic connections between encoder target and read head are established automatically when motor unit and servo drive unit are attached to each other and a wire-free assembly is enabled. The use of the plug connection makes it also possible to automatically establish further connections between servo drive unit and motor unit, for instance a sealing connection or a thermal connection. Consequently, the end cap is no longer required to protect the wires and may in part be omitted or replaced by parts of the servo drive itself. Furthermore, as the wires are no longer required, space is saved and the thermal design of the motor device can be improved. In addition, as the aligning contour not only makes the position feedback of the encoder system precise, but also stabilizes the mechanical connection between servo drive unit and motor unit, such that only few and/or small screws are required for a reliable and tight attachment of motor unit and servo drive unit. As the aligning contour is, by definition, designed to minimize potential movement of motor unit and servo drive unit with respect to each other in a plane perpendicular to the motor shaft, the plugs of the plug connection for the electric coupling are relieved from mechanical stress in the application, so that the reliability of the electric coupling is ensured also in long-term applications. So, the proposed design enables a simplified production and assembly where instead of the known complex processes, a preassembled servo drive unit and a preassembled motor unit can be simply plugged onto each other and fixed with a few screws, thereby resulting in a reliable and simple electrical and optical/magnetic coupling of motor unit and servo drive unit. Additional couplings, such as thermal coupling and/or sealing may also be integrated without the need to change the described electrical and optical/magnetic coupling.

In an advantageous embodiment, the plug connection comprises at least three separate individual plugs, where three of the individual plugs are connected to respective motor phases, and preferably one or more additional plugs of the individual plugs are connected to a motor brake wire and/or a motor temperature sensor wire. The separate design for the individual plugs gives the advantage of a more flexible design regarding the location of the individual plugs. This is advantageous in particular with respect to the different motor phases, which are located in different areas of the motor unit, and with respect to inverter elements in the servo drive unit, usually comprising high-power MOSFETs, which are, due to thermal constraints preferably distributed on as large an area as possible.

Therein, the three separate individual plugs connected to the motor phases may be separated, in a plane perpendicular to the motor shaft, by at least 10°, preferably by at least 45°, most preferably by at least 90°+/−10° or 90°+/−5° or 90°+/−2°. Therein, the degrees are measured from the motor shaft. This arrangement of the separate individual plugs connected to the motor phases has been proven to be particularly advantageous as it allows a well distributed arrangement of the different plugs.

In another advantageous embodiment, the one or more plugs, preferably all plugs, of the plug connection comprise a motor-side plug part, a first plug part, and a servo side plug part, a second plug part, which, in the attached state, are plugged into one another, and are separated from each other in the unattached state. The first plug part comprises an insulating component which isolates a conducting component of the first plug part from a body of the motor unit. In case the first plug part is a male plug part the first plug part may have the form of a pin. Said insulating component comprises a first, inwards-orientated clip which is configured to fix, along the plug direction in a direction parallel to the motor shaft, the conducting component inside the insulating component, as well as a second, outward-orientated clip which is configured to fix, along the plug direction, preferably in opposite direction to the direction of the first clip, together with a flange of the insulating component as counter-support, the insulating component in a hole of the body of the motor unit. This design of the first plug part, has been proven to be specifically advantageous for assembling the motor device, as apparent from the method for assembling a motor device described below.

Therein, it is particularly advantageous if the first clip of the insulating component is configured to be held in a blocking position in which the conducting component cannot be removed from the insulating component, by the walls of the respective hole of the body of the motor unit after the insulating component has been placed in the hole. This increases the stability of the plug and ensures that the conducting part may not be pushed into the motor unit when motor unit and servo drive unit are attached, i.e. plugged onto each other.

Preferably, first and second clips of one individual plus are arranged in an alternating order around the motor-side plug part in a circumferential direction perpendicular to the plug direction. This results in an even distribution of push/pull forces along the plug direction, and allows for an easier installation of the motor-side plug part due to longer levers of the clips.

In a particularly advantageous embodiment, an intersection between motor unit and servo drive unit is not crossed by a wire as mean for electric coupling of motor unit and servo drive unit, preferably not crossed by any wire, in the attached state. This makes sure that the advantages of the electrical coupling via the plug connection and the optical/magnetic coupling made possible by the aligning contour are actually realized and not degraded by non-replaced wires.

In an advantageous embodiment, motor unit and servo drive unit are configured to be attached to each other with four or fewer attachment means, in particular four or fewer screws as attachment means. This gives the advantage of faster and simpler attachment of servo drive unit and motor unit with each other, and is enabled by the alignment contour ensuring sufficient reliability of the mechanical coupling even with few means of attachment.

Another aspect relates to a motor unit for a motor device of any of the described embodiments of the motor device.

A further aspect relates to a servo drive unit for a motor device of any of the described embodiments of the motor device.

Therein, advantages and advantageous embodiments of the motor unit and servo drive unit correspond to the advantages and advantageous embodiments of the described motor devices.

A further aspect relates to a motor device system with more than one type of motor unit of the described embodiments and/or with more than one type of servo drive unit of the described embodiments. There, the plug connection as well as the alignment contour of the respective motor units of the different types and/or the plug connection as well as the alignment contour of the respective servo drive units of the different types are standardized, that is, of preset geometric and electric configuration, such that any type of the respective motor units of the motor device system is configured to be attached to and electrically coupled with any of the one or more different types of servo drive units and vice versa. The different types of motor and servo drive units will differ from each other in at least one characteristic. For instance, the different types of motor unit of the motor device system may have different powers and/or different sizes etc. pp. This gives the advantage that a modular system is realized, where any motor unit of the motor device system can be combined with any servo drive unit of the motor device system, such that the respective motor device can be adapted to the application at hand with minimal effort. Furthermore, the assembly is standardized as well, which reduces failures and allows better training of assembly personal. In addition, the advantages described for the different embodiments of motor unit and or servo drive unit can be achieved by using said embodiments in the motor device system. Motor unit and servo drive unit of the motor data device system may hence comprise any of the features described above for motor unit and/or servo drive unit embodiments.

Yet another aspect relates to a method for assembling a motor device with a motor unit and a servo drive unit. Said method comprises a preparing step of preparing the motor unit with terminating phase wires with respective connector components and with attaching an encoder target to a motor shaft of the motor unit. Each phase wire is a wire electrically coupled to a respective motor phase, i.e. a motor phase winding, of the motor unit. The method also comprises a pushing step of pushing the servo drive unit onto the motor unit in an axial direction of the motor unit (the plug direction) and thereby automatically, i.e. without further explicit action, establishing an electro-mechanical connection of motor unit and servo drive unit. Establishing the electro-mechanical connection therein automatically includes an electrical coupling of the phase wires of the motor unit to corresponding inverter elements such as MOSFETs of the servo drive unit and a radial aligning of motor unit and servo drive unit. The method furthermore comprises fixing the electro-mechanical connection, for instance with screws.

Said termination of the phase wires may comprise a guiding step of guiding at least three phase wires of a motor of the motor unit through respective holes in a plate of motor unit body. It may also comprise an attaching step of attaching, for instance soldering or crimping, a respective conducting component of a motor-side plug part of the respective plug connection, a first plug part of the respective plug connection, onto each of the phase wires. The termination may furthermore comprise a pulling step of pulling a respective insulating component of the first plug part of the respective plug connection over each conducting component, with a respective first clip fixing the respective conducting component in a respective preset position within the respective insulating component, which results in combined insulating and conducting components. The termination then also comprises a subsequent pushing step of pushing the respective combined insulating and conducting components, which are combined by the pulling step, into the respective holes in the plate of the motor unit body, with the respective second clip fixing, with a flange of the insulating component as counter-support, the respective combined insulating and conducting components in a respective preset position in the hole. Thereby, a plug connection for plugging motor unit and servo drive unit onto each other is made possible in an easy and reliable way. Additional wires, for instance brake wires and/or motor temperature sensor wires, may be terminated just as the phase wires. Thus, by pushing the servo drive unit to the motor unit, motor unit and servo drive unit may be electrically coupled via said plug connection including motor phase connections and any other required connection.

Further advantages and advantageous embodiments correspond to the advantages and advantageous embodiments described for the motor device and the motor device system.

The features and combinations of features described above, also in the introduction, as well as the features and combinations of features disclosed in the figure description or the figures alone, may not only be used alone or in the described combination, but also with other features or without some of the disclosed features without leaving the scope of the invention. Consequently, embodiments that are not explicitly shown and described by the figures but that can be generated by separately combining the individual features disclosed in the figures are also part of the invention. Therefore, embodiments and combinations of features that do not comprise all features of an originally formulated independent claim are to be regarded as disclosed. Furthermore, embodiments and combinations of features that differ from or extend beyond the combinations of features described by the dependencies of the claims are to be regarded as disclosed.

### DETAILED DESCRIPTION

Exemplary embodiments are further described in the following by means of schematic drawings. Therein,

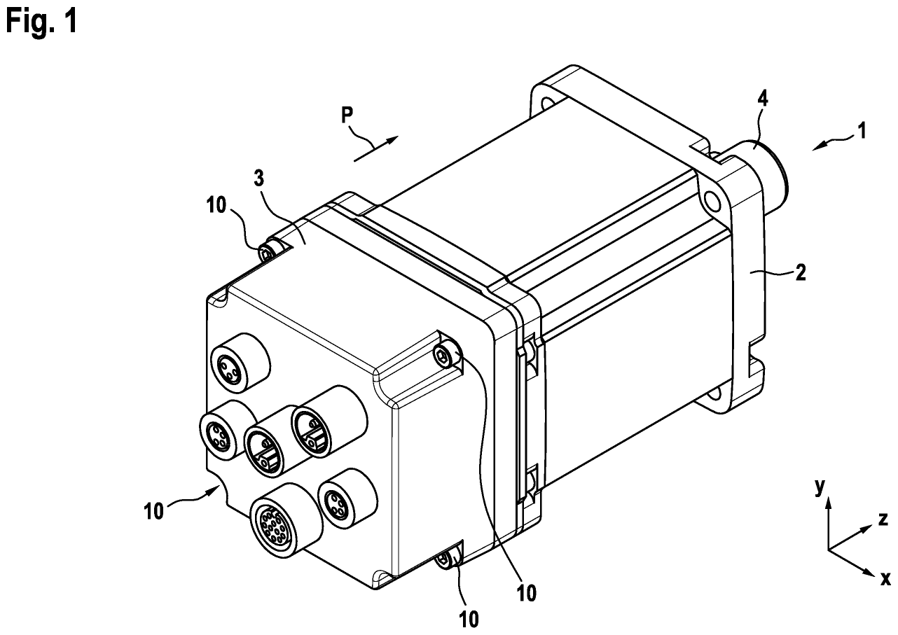

FIG. 1 shows an exemplary embodiment of a motor device with motor unit and servo drive unit in an attached state;

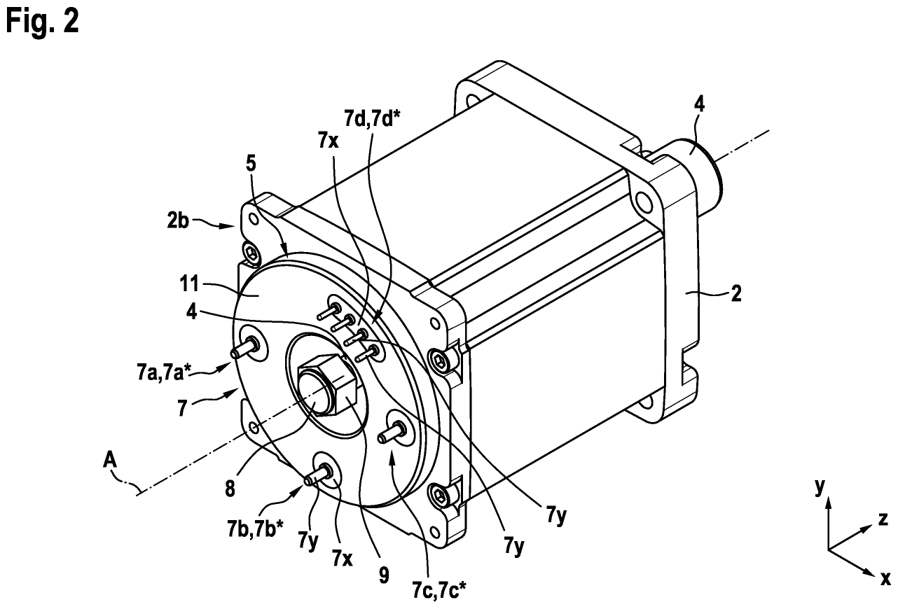

FIG. 2 shows the exemplary motor unit of FIG. 1 in an unattached state of motor unit and servo drive unit;

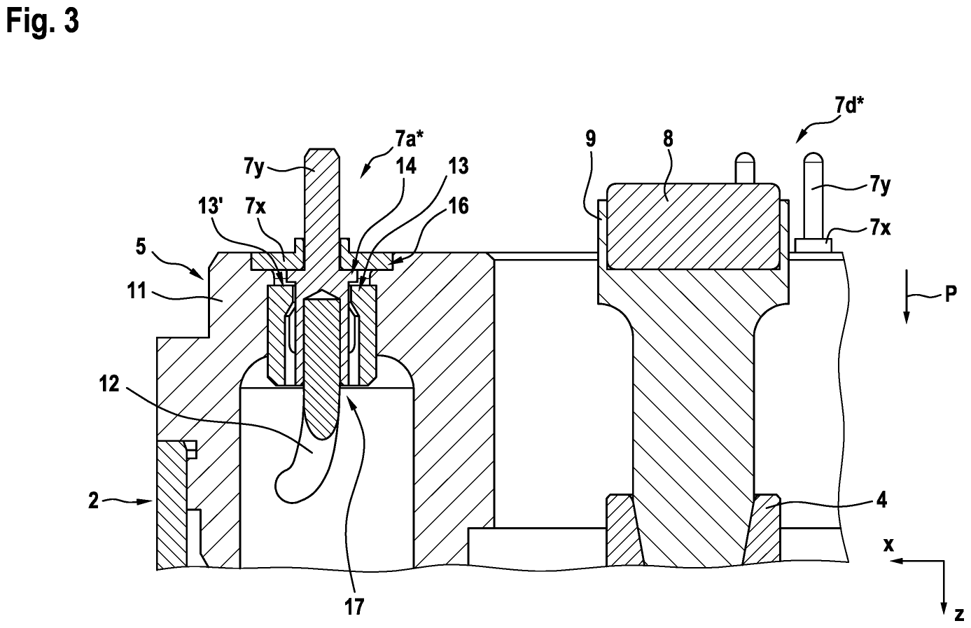

FIG. 3 shows a cross-section through an exemplary motor unit with motor-side plug part and encoder target;

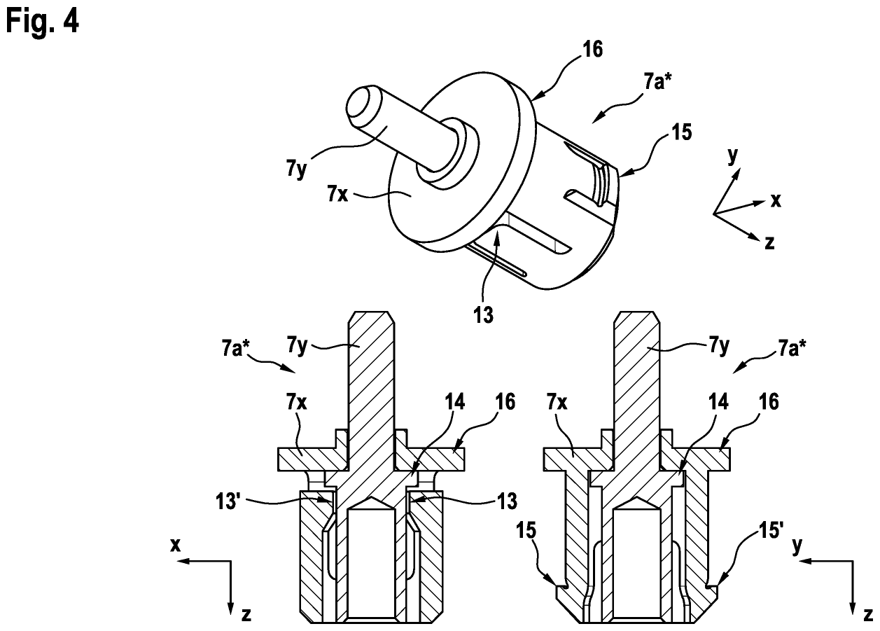

FIG. 4 shows different views on an exemplary embodiment of a motor-side plug part; and

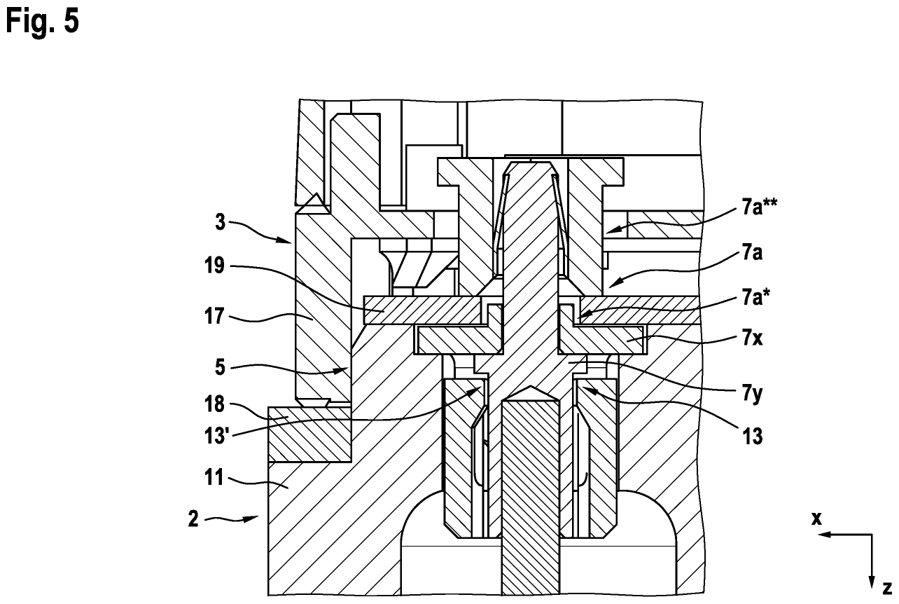

FIG. 5 shows a cross-section corresponding to the cross-section of FIG. 3 in an attached state of motor unit and servo drive unit.

In the different figures, the same reference signs are used for identical or functionally identical features.

FIG. 1 shows a perspective view on a motor device 1 with a motor unit 2, and a servo drive unit 3, which is attached to the motor unit 2 at a backside 2b of the motor unit 2. Although not shown in the figure, motor unit 2 and servo drive unit 3 are electrically coupled via a plug connection 7 (FIG. 2) with one or more plugs 7a-7d (FIG. 2), where a preset plug direction P of the plug connection 7 runs parallel to a motor shaft 4 of the motor unit 2. In the shown example, the servo drive unit 3 is fixed, that is, mechanically coupled, to the motor unit 2 with four attachment means 10 which are screws in the present example.

FIG. 2 shows a perspective view on the motor unit of FIG. 1 with the servo drive unit 3 removed. Consequently, an aligning contour 5, in the present example in the form of a centering flange, as well as the plug connection 7 are now visible. Furthermore, an encoder target 8 fixed to the motor shaft 4, here via an adapter 9, is shown. Note that the corresponding encoder read head, which when the motor device 1 with motor unit 2 and servo drive unit 3 attached to each other is used is required to provide information on the position of the motor shaft 4 is part of the servo drive unit 3 and thus not shown here.

The plug connection 7 comprises at least three, and the present example four separate individual plugs 7a, 7b, 7c, and 7d. Three of the individual plugs 7a, 7b, 7c are connected to respective motor phases 12 (FIG. 3), and the additional plugs 7d is, in the present example, connected to a motor brake wire and a motor temperature sensor wire. The three separate individual plugs 7a, 7b, 7c connected to the motor phases are separated, in the present example, by at least 90°, measured from the motor shaft 4, that is, a rotating axis A of the motor shaft 4. Note that the individual plugs 7a, 7b, 7c each connect a single wire, the respective motor phase 12, and the additional plug 7c connects more than one, here 4 wires to the the sensor drive unit 3.

The plugs, 7a, 7b, 7c, 7d are shown with their respective motor-side plug parts 7a*, 7b*, 7c*, 7d*. Each of the motor-side plug parts 7a*, 7b*, 7c*, 7d* comprises an insulating component 7x, which isolates a conducting component 7y of the respective plug part 7a*, 7b*, 7c*, 7d* from a body 11 of the motor unit 2.

FIG. 3 shows a cross section showing the details of the respective motor-side plug part 7a* as representative example for all the motor-side plug parts 7a*, 7b*, 7c*, 7d* of the present embodiment. The insulating component 7x comprises two first clips 13, 13′ which are configured to fix, along the plug direction P, a direction parallel to the motor shaft 4, the conducting component 7y in the insulating component 7x. To this end, the conducting component 7y comprises a flange 14 that engages with the first clips 13, 13′. The clips 13, 13′ hinder the conducting component 7y to be moved inside the body 11 when the servo drive unit 3 is attached to motor unit 2, i.e. plugged onto the motor unit 2 in the plug direction P.

The insulating part 7x also comprises two second clips 15, 15′ not shown in FIG. 3 which are configured to fix, along the plug direction, with a flange 16 as counter-support, the insulating component 7x in a hole 17 of the body 11 of the motor unit 2. Consequently, in an assembled state, the first clips 13, 13′ are pressed towards the conducting component 7y, thus locking the conducting component 7y inside the insulating component 7x.

FIG. 4 shows one perspective view and two cross sections of the motor-side plug part 7a* of FIG. 3, with details of the first and second clips 13, 13′, 15, 15′ and the corresponding flanges 14, 16. In particular, it is shown that the respective two first clips 13, 13′ as well as the respective two second clips 15, 15′ are each arranged on opposite sides of the insulating component 7x. In this example, said first and second clips 13, 13′, 15, 15′ are arranged in an alternating order in a circumferential direction around the motor-side plug part 7a* in the x-y-plane.

FIG. 5 shows a cross-section corresponding to FIG. 3, with the servo drive unit 3 attached to the motor unit 2. At the alignment contour 5, the body 11 of the motor unit 2 is in direct contact with the housing 17 of the servo drive unit 3, thus resulting in a very precise and mechanically robust attachment of the servo drive unit 3 the motor unit 2, which also prevents even minimal movements of the servo drive unit 3 with respect to the motor unit 2. Even such minimal movements would deteriorate the plug connection 7a in the long term. In the present example, a ring element 18 is further introduced between the housing 17 and the body 11 for sealing purposes. This ring element 18 may be omitted, however.

In addition to the motor-side plug part 7a*, also the servo-drive-side plug part 7a** is shown. This servo-drive-plug part 7a** is, in the present example attached directly to a board of 19 and thus realizes a wireless board-to-body connection between servo drive unit 3 and motor unit 2.

Moreover, the servo-drive plug part 7a** is in contact with its corresponding printed circuit board 19 only in a planar (not in a radial) manner. Thus, the surface of the printed circuit board 19 being in touch with the servo-drive plug part 7a** is the surface of the printed circuit board 19 remote from the motor unit 2, opposite of the surface facing the motor unit 2, which is equipped with entry holes for the pins forming the conducting components 7y here. This design differs from state-of-the-art PCB-mounted pin-receptacles which are typically stretched out into or through their corresponding hole in the PCB. The proposed design gives thermal advantages as it allows the printed circuit board 19 to be in planar contact with the body 11. In particular, it allows the use of a printed circuit board with integrated metallic substrate, which in turn further facilitates thermal coupling between body 11, printed circuit board 19 and components on the latter, i.e. motor unit 2 and servo drive unit 3.

1-14. (canceled)

15. A motor device with a motor unit and a servo drive unit configured to be attached to the motor unit, where the motor unit and servo drive unit are configured to be electrically coupled via a plug connection with one or more plugs, with a preset plug direction of the plug connection running parallel to a motor shaft of the motor unit; characterized by:
an encoder system for providing information on the position of the motor shaft with i) an encoder target which is fixed to the motor shaft of the motor unit as part of the motor unit and with ii) an encoder read head which is a part of the servo drive unit; where the encoder target is part of the motor unit both in the attached state of motor unit and servo drive unit and in an unattached state of motor unit and servo drive unit, and the encoder read head is part of the servo drive unit both in the attached state of motor unit and servo drive unit and in the unattached state of motor unit and servo drive unit; and in that
the motor unit and the servo drive unit are configured to be aligned, in an attached state of motor unit and servo drive unit, by means of an aligning contour.

16. The motor device of claim 15, characterized in that:
the servo drive unit and motor unit have respective single housings, and the alignment contour comprises one or more parts of one or both of the housings.

17. The motor device of claim 16, characterized in that:
the plug connection comprises at least three separate individual plugs, where three of the individual plugs are connected to respective motor phases, and preferably one or more additional plugs of the individual plugs are connected to motor brake wires and/or motor temperature sensor wires.

18. The motor device of claim 17, characterized in that:
the three separate individual plugs connected to the motor phases are separated, in a plane perpendicular to the motor shaft, by at least 10°, measured around the motor shaft.

19. The motor device of claim 17, characterized in that:
the three separate individual plugs connected to the motor phases are separated, in a plane perpendicular to the motor shaft, by at least 45°, measured around the motor shaft.

20. The motor device of claim 17, characterized in that:
the three separate individual plugs connected to the motor phases are separated, in a plane perpendicular to the motor shaft, by at least 90°+/−10°, measured around the motor shaft.

21. The motor device of claim 15, characterized in that:
the one or more plugs of the plug connection comprise a motor-side plug part, a first plug part, and a servo-drive-side plug part, a second plug part,
where the first plug part comprises an insulating component which isolates a conducting component of the first plug part from a body of the motor unit,
where the insulating component comprises:
a first clip configured to fix, along the plug direction, the conducting component in the insulating component, and
a second clip configured to fix, along the plug direction, with a flange as counter-support, the insulating component in a hole of the body of the motor unit.

22. The motor device of claim 21, characterized in that:
the first and second clips are arranged in an alternating order around the motor-side plug part in a circumferential direction perpendicular to the plug direction.

23. The motor device of claim 21, characterized in that:
the first clip of the insulating component is configured to be held in a blocking position, in which the conducting component cannot be removed from the insulator component, by the walls of the hole of the body.

24. The motor device of claim 15, characterized in that:
all plugs of the plug connection comprise a motor-side plug part, a first plug part, and a servo-drive-side plug part, a second plug part,
where the first plug part comprises an insulating component which isolates a conducting component of the first plug part from a body of the motor unit,
where the insulating component comprises:
a first clip configured to fix, along the plug direction, the conducting component in the insulating component, and
a second clip configured to fix, along the plug direction, with a flange as counter-support, the insulating component in a hole of the body of the motor unit.

25. The motor device of claim 15, characterized in that:
an intersection between the motor unit and servo drive unit is not crossed by a wire electric coupling of the motor unit and servo drive unit in the attached state.

26. The motor device of claim 15, characterized in that:
an intersection between the motor unit and servo drive unit is not crossed by any wire in the attached state.

27. The motor device of claim 15, characterized in that:
the motor unit and servo drive unit are configured to be attached to each other with four or fewer attachment means.

28. The motor device of claim 15, characterized in that:
the motor unit and servo drive unit are configured to be attached to each other with four or fewer screws as attachment means.

29. A motor device system with more than one type of motor units of the preceding claim and/or with more than one type of servo drive units of claim 15, where the plug connection as well as the alignment contour of the respective motor units of the different types of motor units and/or the plug connection as well as the alignment contour of the respective servo drive units of the different types of servo drive units are standardized such that any type of the respective motor units is configured to be attached to and electrically coupled with any of the one or more different types of servo drive units, and vice versa.

30. A method for assembling a motor device with a motor unit and a servo drive unit, with the method steps of:
preparing the motor unit with terminating phase wires with respective connector components and with attaching an encoder target to a motor shaft of the motor unit;
pushing the servo drive unit onto the motor unit in an axial direction of the motor unit and thereby automatically establishing an electro-mechanical connection of motor unit and servo drive unit including an electrical coupling of the phase wires of the motor unit to corresponding inverter elements of the servo drive unit and a radial aligning of motor unit and servo drive unit; and
fixing the electro-mechanical connection.

31. The method of claim 30, characterized in that:
terminating the phase wires comprises:
guiding at least three phase wires of a motor of the motor unit through respective holes in a motor unit body;
attaching a respective conducting component of a motor-side plug part of a respective plug connection, a first plug part of the respective plug connection, on each of the phase wires;
pulling a respective insulating component of the first plug part of the respective plug connection over each conducting component, with a respective first clip fixing the respective conducting component in a respective preset position in the respective insulating component; and
pushing the respective combined insulating and conducting components into the respective holes in the motor unit body with a respective second clip fixing, with a flange as counter-support, the respective combined insulating and conducting components in a respective preset position in the hole.
